(19) United States
(12) Patent Application Publication
(10) Pub. No.: US 2025/0262471 A1
(43) Pub. Date: Aug. 21, 2025

(54) ACTUATOR GEARED FEEDBACK SYSTEM FOR A RESISTANCE TRAINING MACHINE AND METHODS OF USE

(71) Applicant: Speede Fitness, LLC, Lake Zurich, IL (US)

(72) Inventors: Daniel Mooney, Wauconda, IL (US); Mark W. Schwartz, Wauconda, IL (US); Erik Lutz, Wauconda, IL (US); Stanislav Dmitriyev, Chervonohrad (UA); Nazar Pelenjo, Lviv (UA)

(21) Appl. No.: 19/049,611

(22) Filed: Feb. 10, 2025

Related U.S. Application Data
(60) Provisional application No. 63/554,612, filed on Feb. 16, 2024.

(51) Int. Cl. A63B 21/005; A63B 24/00; F16H 57/029

(52) U.S. Cl. CPC A63B 21/0058; A63B 24/0087; F16H 57/029

(57) ABSTRACT

Provided herein are Actuator Geared Feedback Systems for a Resistance Training Machines and Methods of Use.

### CROSS-REFERENCE TO RELATED APPLICATIONS

The present application claims priority to U.S. provisional application Ser. No. 63/554,612, filed Feb. 16, 2024, herein incorporated by reference in its entirety.

### BACKGROUND

The invention generally relates to geared systems for a resistance training machine.

Resistance training is a form of exercise undergone to build muscular strength and endurance by working against a weight or applied force. While some resistance training routines can be accomplished without external equipment, i.e., bodyweight exercises, many others require the use of specialized equipment, such as but not limited to free weights, weight machines, cable machines, resistance bands, and the like.

Traditional resistance training equipment is often specialized and, while each piece of equipment may offer distinct advantages, each may also suffer from drawbacks and inefficiencies. For example, free weights and weight machines are commonly employed for isotonic exercises, i.e., exercises requiring muscle activation against a constant force across a given range of motion. However, adjusting the weight or force for such exercises can be inconvenient, often requiring a user to add or remove plates, install clips, swap out dumbbells, etc. Furthermore, initiating an exercise with free weights and weight machines can create undue strain on a user's body, since the force applied by such equipment acts as a step function—jumping from zero to the full resistance. Perhaps more importantly, traditional resistance training equipment is usually designed for specific exercises or specific exercise modes only, requiring an individual to own a plurality of equipment in order to access a variety of well-rounded exercises.

More recently, ‘smart’ exercise machines have been developed that claim to offer a number of different exercises in a single machine. These machines commonly operate by providing resistive forces through electronic motors, which may be adjusted to the user's strength level. However, the exercise machines disclosed by the prior art have consistently failed to provide a range of exercise modes or can provide some modes but fail in others. Moreover, such machines tend to be limited in the amount of force they produce; they are usually unwieldy and difficult to install or transport; and many fail to provide adequate safety measures for the user. Finally, neither traditional resistance training equipment nor newer exercise machines offer feedback regarding both user form and user balance during workouts.

In the perfect world, the gear shifts during workouts have perfect mechanical, angular alignment of the splines and shifts every time. In practice, this is not the case as the center spline male can get stuck on the female alignment spline. Accordingly, there remains a need in the art for a geared system to control shifting of gears in a resistance training machine.

### SUMMARY OF THE INVENTION

Provided herein are Actuator Geared Feedback Systems for a Resistance Training Machines and Methods of Use.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1A is a perspective view of the multi-motor resistance training machine, according to one embodiment; FIG. 1B is a perspective view of the multi-motor resistance training machine without the HMI, according to one embodiment.

FIG. 2A is a cut-away perspective view of the multi-motor resistance training machine, according to one embodiment; FIG. 2B is a cut-away perspective view of the multi-motor resistance training machine without the HMI, according to one embodiment.

FIG. 3A is a side view of the actuator geared system, according to one embodiment; FIG. 3B is a top view of the actuator geared system, according to one embodiment; FIG. 3C is a side view of the actuator geared system showing the shaft spline engaged with the lower gear; FIG. 3D is a top view of the actuator geared system, according to one embodiment; FIG. 3E is a side view of the actuator geared system showing the shaft spline in the neutral position; FIG. 3F is a side view of the actuator geared system, according to one embodiment; and FIG. 3G is a top view of the actuator geared system, according to one embodiment.

FIG. 4A is a side view of the high gear including the plurality of female engagement points, according to one embodiment; FIG. 4B is a perspective view of the shaft spline including the plurality of male engagement points in the conical profile, according to one embodiment; FIG. 4C is a side view of the low gear including the plurality of female engagement points in the conical configuration, according to one embodiment.

FIG. 5A is a top view of the plurality of male engagement points showing a chauffeured profile, according to one embodiment; FIG. 5B is a top view of the plurality of male engagement points showing a conical profile, according to one embodiment; and FIG. 5C is a top view of the plurality of male engagement points showing an angled chauffeured profile, according to one embodiment.

FIG. 6A is a perspective view of the actuator with a stacked wave disc spring, according to one embodiment; FIG. 5B is a perspective view of the actuator with a sheet metal spring, according to one embodiment; and FIG. 5C is a perspective view of the actuator with a compression spring, according to one embodiment.

FIG. 7 is a flowchart outlining a geared system module, according to one embodiment.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes, or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.,” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the mechanical, software, and electrical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### Description of Embodiments

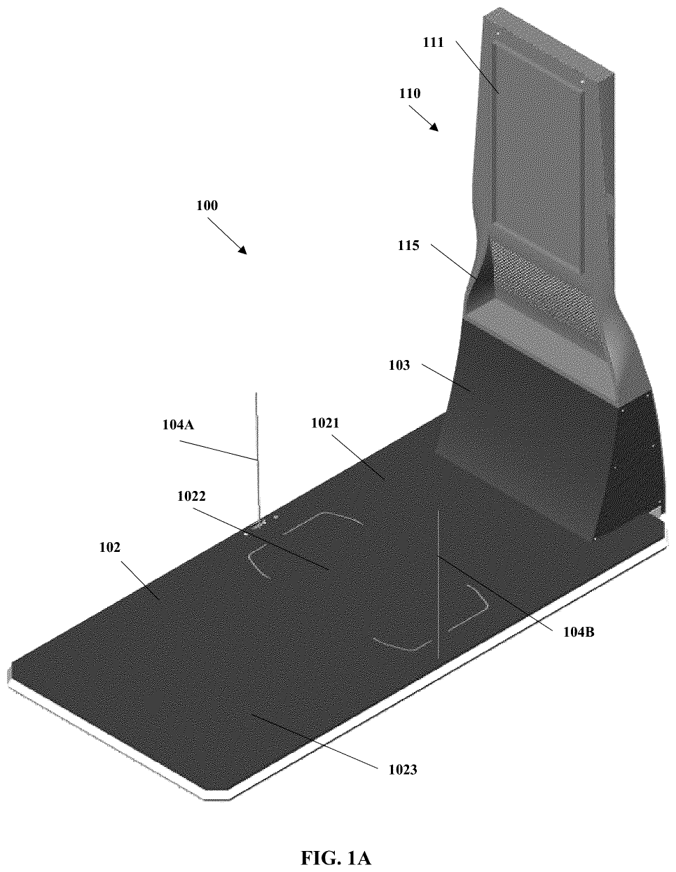

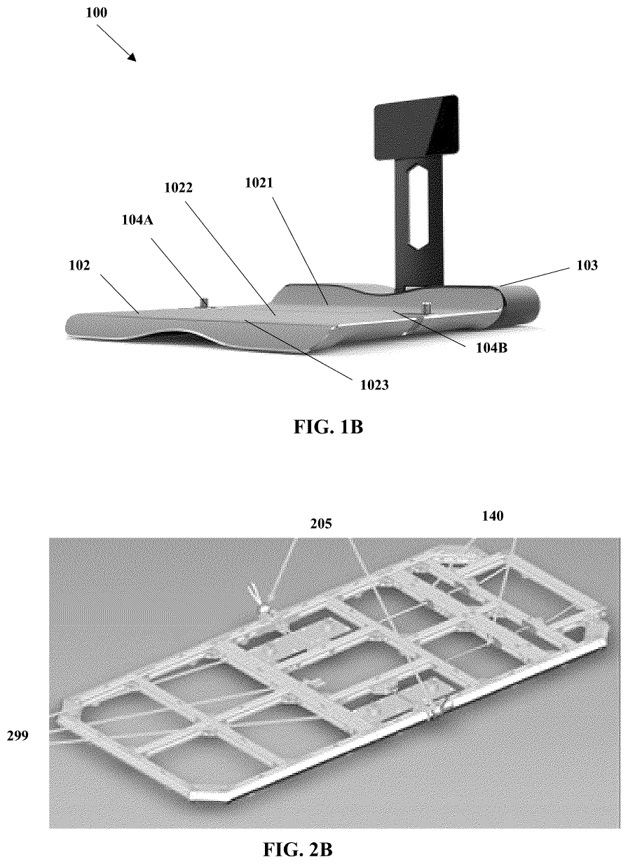

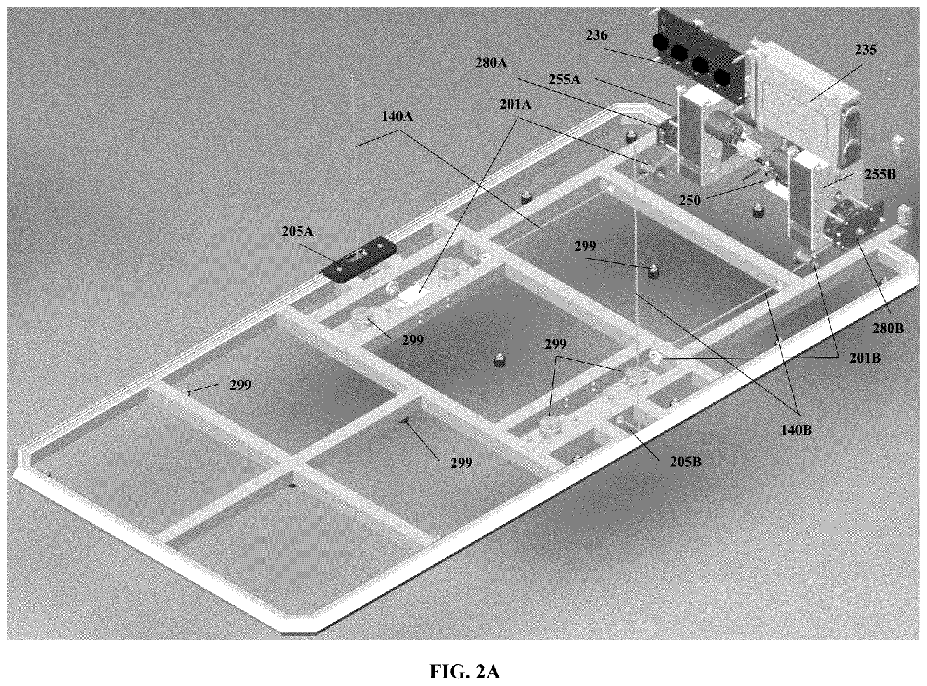

Referring now to the drawings and with specific reference to FIGS. 1A-1B, a diagram of a multi-motor resistance training machine is generally referred to by a reference numeral 100 and may be generally referred to as machine or resistance training machine. The multi-motor resistance training machine 100 may be situated in a home, apartment, hotel, commercial gym, and the like, and may be capable of enabling both isotonic exercises and isokinetic exercises at varying force and velocity levels, respectively, for a user. Furthermore, the resistance training machine may measure and communicate form feedback, force feedback, velocity feedback, position feedback, calibration feedback, and balance feedback during some or all exercises performed on the machine 100, thereby improving workout efficacy and safety for the user. As seen in FIGS. 1-2, the multi-motor machine 100 may comprise at least a platform 102, a left cable 140A, a right cable 140B, and a human-machine interface (HMI) 110 to select one or more exercise modes. The resistance training machine 100 may comprise the platform 102 for a user to stand on and engage in exercises, wherein the platform may include a front section 1021, a middle section 1022, and a rear section 1023. An electromagnetic assembly (EM) 103 may be attached to the front section 1021, and a front upright stand 115 may be attached to and extend vertically from the EM assembly 103 to display the HMI 110. In one embodiment, the exercise machine 100 may only comprise the platform 102 and EM assembly is incorporated into the platform 102 without the HMI 110, as shown in FIGS. 1B and 2B. The EM assembly 103 operates with multi-motors to provide resistance training for isotonic exercises and isokinetic exercises in a plurality of modes. The multi-motors work together to provide left and right movements on the resistance training machine, where the multi-motors work in parallel with a speed gear box to employ a low force and a high-speed work out and a slower speed but a high force work out.

### Actuator Geared Feedback System

The resistance training machine provides high torque, constant velocity, variable force in the Isokinetic mode and constant force, variable speed, lower torque in the Isotonic Mode. In order to switch between modes, the modes require that there are at least two gear trains for each unique mode. This resistance training machine includes an electronic actuator where a center gear moves to engage one mode or the other mode. If the shift has perfect mechanical, angular alignment of the splines, teeth, or engagement points and shifts every time. However, if the center spline male teeth get stuck on the female alignment spline teeth, the actuator geared system uses a feedback system and endpoint teeth profiles to ensure the proper action to make the second shift work 100% of the time. Splines, teeth, or engagement points may be used interchangeably that signifies the geared system meshes with two gears as to provide an interlocking gear system for movement, resistance, or transmitting force for an exercise machine.

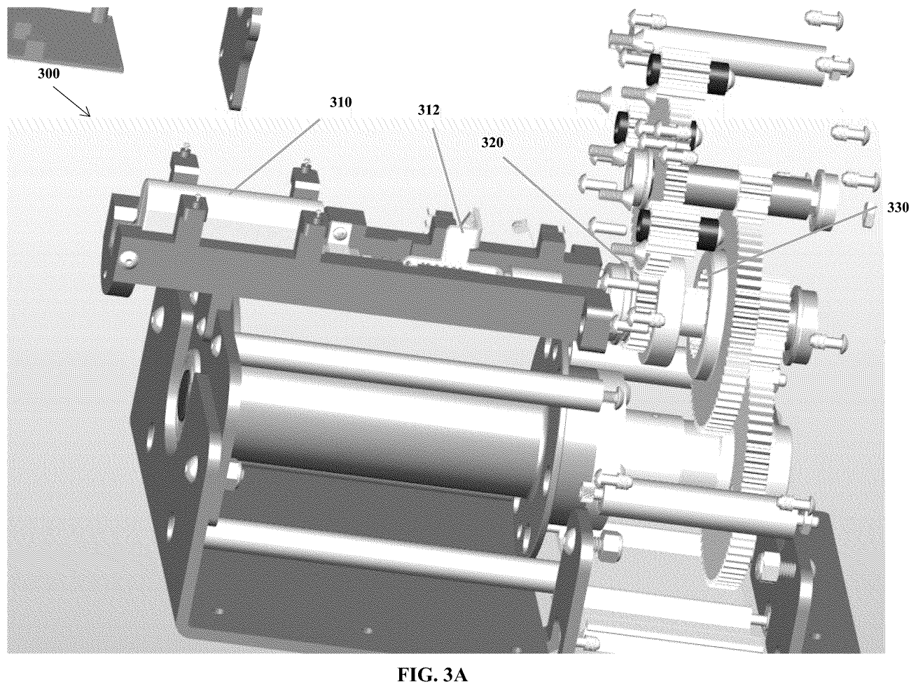

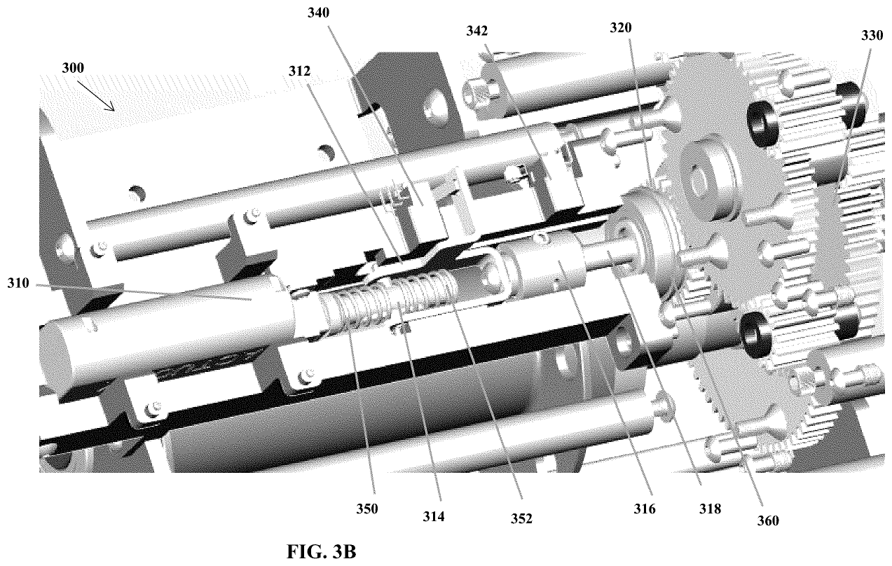

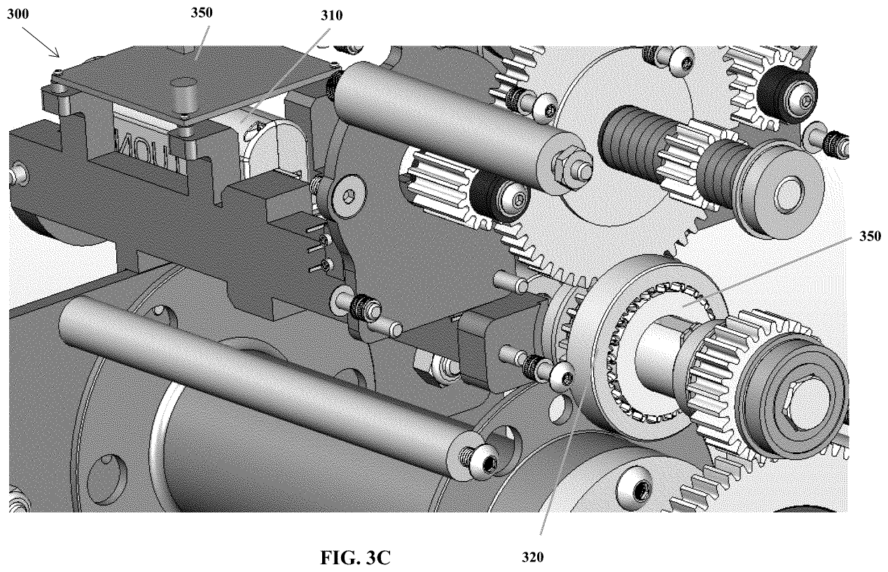

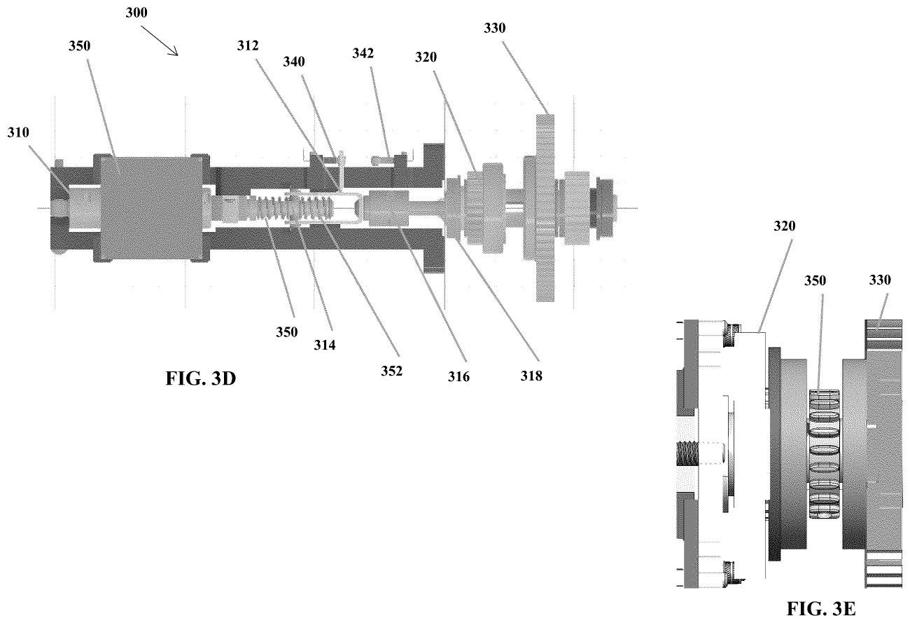

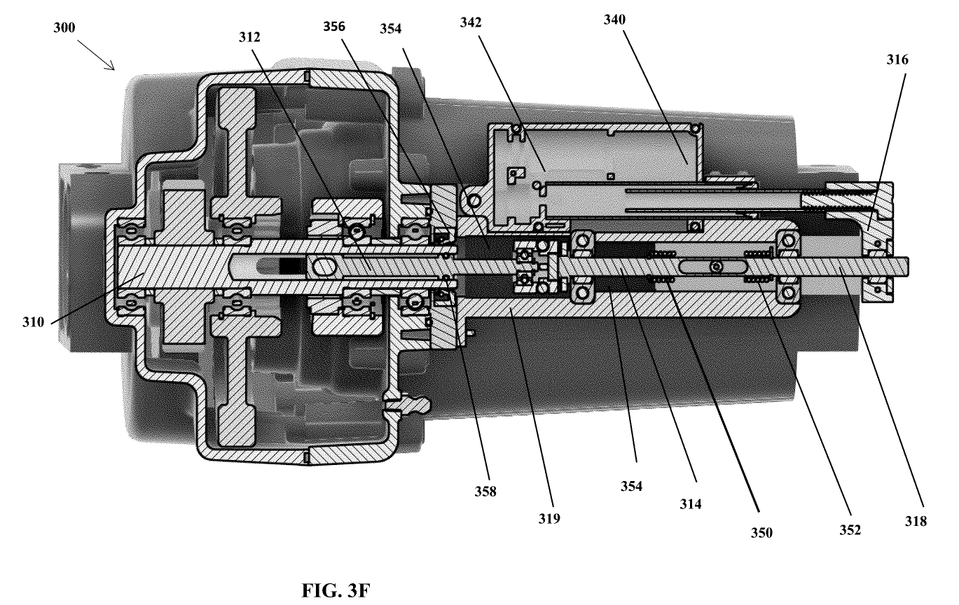

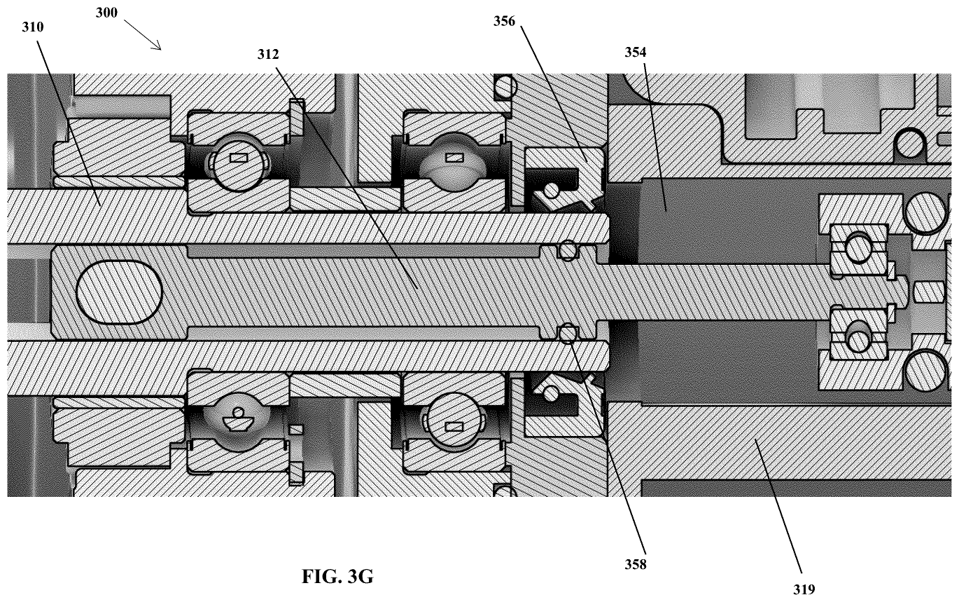

As shown in FIGS. 3A-3D, the actuator geared system 300 for a resistance training machine, comprises an actuator 310 operably coupled to a motor, wherein the motor is operable to provide resistance, force, or velocity in a resistance training machine. The actuator 310 shifts the motor system from a lower gear 320 to a higher gear 330 in a first actuator position, and the actuator 310 shifts the motor system from the higher gear 330 to the lower gear 320 in a second actuator position. The higher gear 330 may be synonymously referred to as the larger gear 330 and the lower gear 320 may be synonymously referred to as the smaller gear 320. In one embodiment, the higher gear 330 and the second actuator position is for the isotonic exercise mode. In one embodiment, the lower gear 320 and the first actuator position is for the isokinetic exercise mode. As shown in FIGS. 3B-3C, the actuator 310 is operably coupled to an actuator shaft 312 and a spring adaptor 314, which is coaxially surrounded by a first spring 350 and a second spring 352. The actuator shaft 312 is operably coupled to an actuator clutch 316 and a shifter shaft 318 that longitudinally translates a shaft spline 360 from engaging or meshing with the small gear 320, as shown in FIG. 3C, to engaging or meshing with the high gear 330 (not shown). The actuator shaft 312 is operably coupled to a first switch 340 and a second switch 342, which provides feedback on the first actuator position and the second actuator position. When in the first actuator position, the actuator shaft 312 and the first switch 340 are engaged to indicate and confirm the first actuator position. In operation, the actuator 330 longitudinally translates the actuator shaft 312 towards the motors to move from the first actuator position to the second actuator position. When the actuator shaft 312 is in the second actuator position, the actuator shaft 312 engages the second switch 342 as to signal and confirm that the second actuator position is engaged. If neither the first switch 340 or the second switch 342 are operably engaged with the actuator shaft 312, then the actuator 310 is in the neutral position, which is between the first actuator position and the second actuator position, as shown in FIG. 3E. The first spring 350 and the second spring 352 longitudinally bias the actuator shaft 312 towards the high gear if the second actuator position is not achieved for a complete gear mating. A variety of springs may be used for the first spring 350 and the second spring 352, as indicated below.

As shown in FIG. 3C, an actuator control board 302 sends the signal to the actuator 310 to move from the first actuator position to the second actuator position and from the second actuator position to the first actuator position. The actuator control board 302 may be operably coupled with the machine controller of the exercise machine to indicate and confirm isotonic and isokinetic exercises. In one embodiment, the shaft spline 360 is in the neutral position between the first actuator position of the lower gear 320 and the second actuator position with the higher gear 330, as shown in FIG. 3E.

Cross section of the O-ring that keeps oil from leaking past the inner shifter shaft.

The light pink component cross section above and below the outer shifter shaft is the rotary seal that keeps oil from leaking out of the area around the outer shifter shaft.

As shown in FIGS. 3F-3G, another embodiment of the actuator geared system 300 for a resistance training machine, where the actuator 310 is operably coupled to the actuator shaft 312 and the spring adaptor 314, which is coaxially surrounded by the first spring 350 and the second spring 352. The actuator shaft 312 is operably coupled to an actuator clutch 316 and a shifter shaft 318 that longitudinally translates the shaft spline 360 from engaging or meshing with the small gear 320, as shown in FIG. 3C, to engaging or meshing with the high gear 330 (not shown). The actuator shaft 312 is operably coupled to the first switch 340 and the second switch 342, which provides feedback on the first actuator position and the second actuator position. The outer shifter shaft 318 includes oil 354 that smooths the shifting of the actuator and an O-ring 358 that keeps oil from leaking past the inner shifter shaft 312. A rotary seal 356 above and below the outer shifter shaft 319 keeps oil 354 from leaking out of the area around the outer shifter shaft 319, as shown in FIG. 3G. When in the first actuator position, the actuator shaft 312 and the first switch 340 are engaged to indicate and confirm the first actuator position. In operation, the actuator 330 longitudinally translates the actuator shaft 312 towards the motors to move from the first actuator position to the second actuator position. The oil 354 smooths the translation and shifting of the actuator shaft 312. When the actuator shaft 312 is in the second actuator position, the actuator shaft 312 engages the second switch 342 as to signal and confirm that the second actuator position is engaged. If neither the first switch 340 or the second switch 342 are operably engaged with the actuator shaft 312, then the actuator 310 is in the neutral position, which is between the first actuator position and the second actuator position, as shown in FIG. 3E. The first spring 350 and the second spring 352 longitudinally bias the actuator shaft 312 towards the high gear if the second actuator position is not achieved for a complete gear mating. A variety of springs may be used for the first spring 350 and the second spring 352, as indicated below.

In one embodiment, the electronic actuator is operably coupled with a two-speed gear box and includes force to shift into the first actuator position, the second actuator position, and the neutral position. In one embodiment, the gear box utilizes a center gear between desired gear ratios, where each gear ratio corresponds to two workout, electronic weight modes, Isokinetic or constant velocity and variable force based on user resistance.

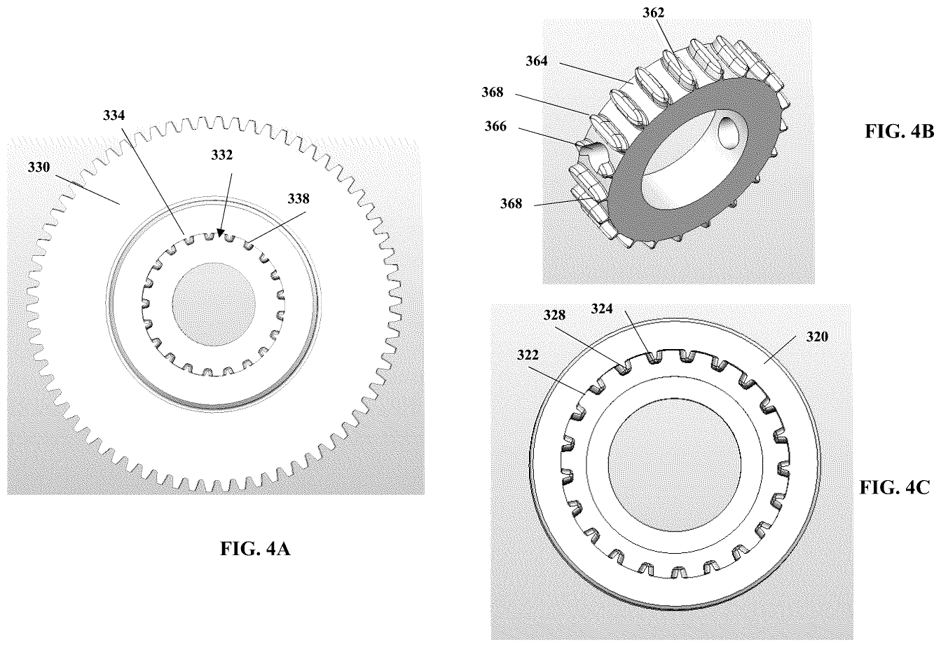

As shown in FIG. 4A, the higher gear 330 includes a plurality of female engagement points 332 separated by a plurality of outer teeth 334. As shown in FIG. 4B, the shaft spline 360 includes a plurality of male engagement points 362 separated by a plurality of teeth receiving portions 364 and a pin hole traversing the circumference of the shaft spline 360. A pin secures the shaft spline to the shifter shaft 318 and includes a breakaway strength of about 460 MPa. As shown in FIG. 4C, the small gear 320 includes a plurality of female engagement points 322 separated by a plurality of outer teeth 324. In operation, the shaft splint 360 engages with the higher gear 330 when the actuator longitudinally traverse and the plurality of female engagement points 332 of the higher gear 330 engage and lock with the plurality of male engagement points 362 of the shaft spline 360 in the second actuator position. When the actuator longitudinally traverses to the small gear 320, the plurality of female engagement points 322 of the small gear 320 engage and lock with the plurality of male engagement points 362 of the shaft spline 360 in the first actuator position. The plurality of male engagement points 362 include pointed ends 368, the plurality of outer teeth 334 of the higher gear 330 include pointed ends 338, and the plurality of outer teeth 324 of the small gear include pointed ends 328. If the shaft spline 360 is unable to engage with the higher gear 330 due to the pointed ends 368 of the plurality of male engagement points 362 abutting the pointed ends 338 of the plurality of outer teeth 334, the first spring or the second spring will provide a force the plurality of male engagement points 362 to lock into the plurality of the female engagement points 332 due to the angled nature of the pointed ends 368 and 338.

The actuator 310 includes a plurality of male engagement points 312 for the higher gear 330, such that the plurality of male engagement points 312 lock into the plurality of female engagement points 332 as to lock the actuator 310 in the first actuator position, and preventing a failed shift of the actuator 310 from the lower gear 320 to the higher gear 330 if the plurality of male engagement points 312 do not lock into the plurality of female engagement points 332, then the actuator 310 rotates at least one degree as to lock the plurality of male engagement points 312 into the plurality of female engagement points 332.

As shown in FIG. 4A, the high gear 330 includes a central axle with a plurality of female engagement points 332 separated by and the plurality of male engagement points are between about 3 and about 42. The corresponding plurality of male engagement points 362 are equal to the plurality of female engagement points 332 and 322 and may be between about 3 and about 42. As shown in FIG. 4C, the plurality of female engagement points and the plurality of male engagement points include a triangular configuration. As shown in FIG. 4B, the plurality of female engagement points and the plurality of male engagement points include a circular configuration. In one embodiment, the plurality of female engagement points and the plurality of male engagement points include a square configuration.

In one embodiment, the low gear is between about 1.6:1 and about 4.8:1 and the high gear is between about 22:1 to about 66:1. The high gear may apply a torque of about 20.8 N or about 500 lbs of pulling force. In one embodiment, the actuator is operably coupled to the machine controller. In one embodiment, the higher gear operates in an isokinetic mode and the lower gear operates in an isotonic mode or a calibration mode. In one embodiment, the motor system further comprises a neutral gear between the higher gear and the lower gear.

In operation, the actuator is activated to move from the first actuator position to the second actuator position with an actuator force between about 20N and about 90 N, or the actuator is activated move from the second actuator position to the first actuator position with an actuator back force of about between about 100N and 200 N. If the actuator reports that the actuator did not travel to the first actuator position from the second actuator position, then the controller operates a geared system module 350.

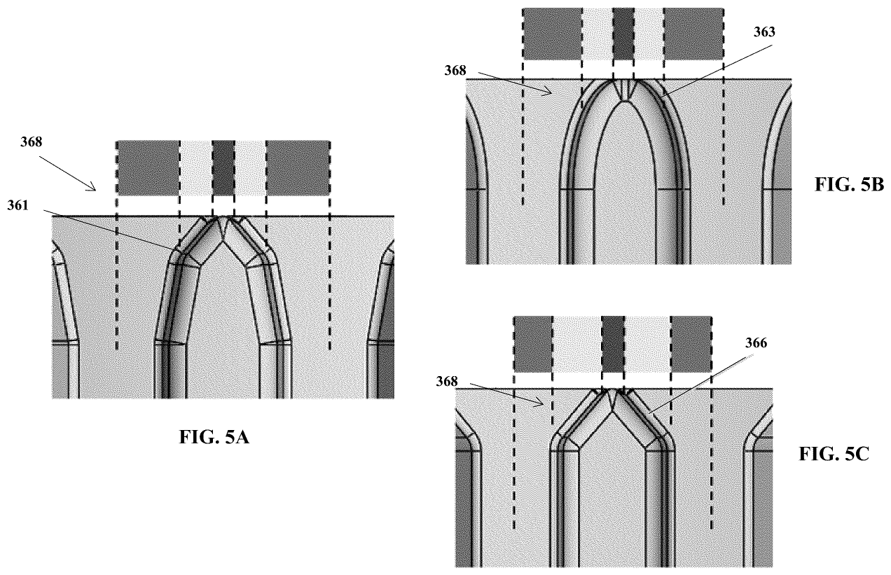

As shown in FIG. 5A, the endpoints 368 of the shaft spline 360 includes double chamfered lead-in male teeth 361 that includes a touch point for the shaft spline that engages with the plurality of female engagement points 332 and 322 of the high gear 330 and low gear 320, respectively. As shown in FIG. 5B, the endpoints 368 of the shaft spline 360 includes conical round shape teeth 363 that includes a touch point for the shaft spline that engages with the plurality of female engagement points 332 and 322 of the high gear 330 and low gear 320, respectively. As shown in FIG. 5C, the endpoints 368 of the shaft spline 360 includes 45 degree chamfered lead-in male teeth 366 that includes a touch point for the shaft spline that engages with the plurality of female engagement points 332 and 322 of the high gear 330 and low gear 320, respectively. In one embodiment, there are about 21 male engagement points and 21 female engagement points, such that there is a 6% the endpoints may abut each other and prevent a gear shift to the second actuator position or the first actuator position.

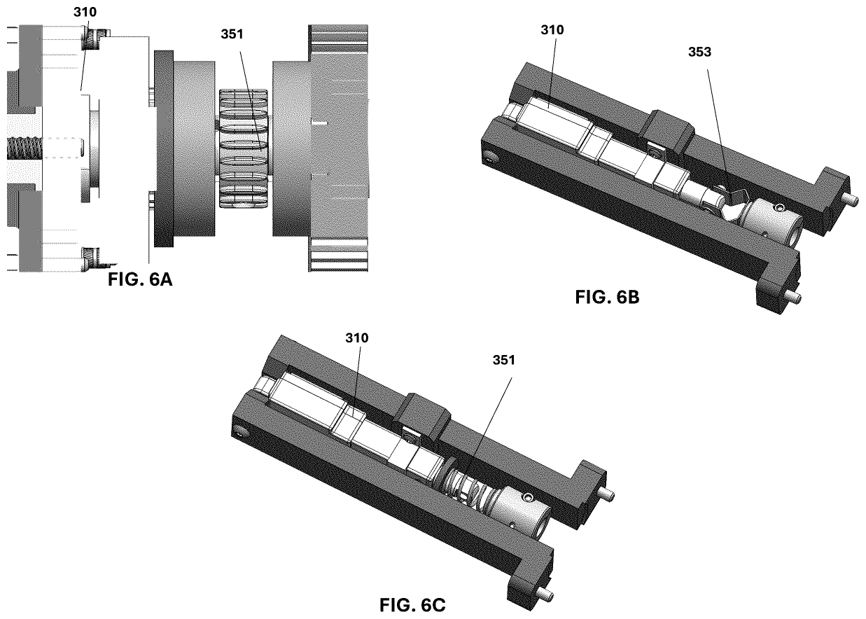

As shown in FIG. 6A, the actuator 310 may be biased with a stacked wave disc spring 351 that includes a working load of about 15 lbs. As shown in FIG. 6B, the actuator 310 may be biased with a bronze sheet metal spring 353. As shown in FIG. 6C, the actuator 310 may be biased with a compression spring 353 with a load force between about 17 lbs and about 20 lbs.

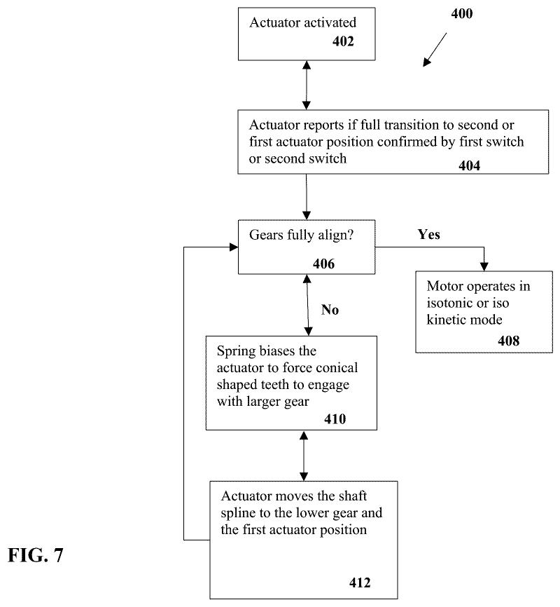

As shown in FIG. 7, the actuator geared system module 400 includes a step 402 where the actuator is activated. The actuator reports in step 404 if the actuator did not make a full engagement with the higher gear to the second actuator position if the second switch is not activated or a full engagement with the lower gear in the first actuator position if the first switch is not activated. Step 406 determines if the gears mechanically align and the plurality of female engagement points are locked into the plurality of male engagement points of the actuator. If the gears mechanically aligned, then step 408 allows the motor to operate in the isotonic or isokinetic mode for the exercise machine in step 360. If the gears did not mechanically align, then step 358 allows the spring to bias the actuator to force the conical shaped teeth to engage the larger gear for the isotonic mode. Then, in step 412 if isokinetic mode is needed the actuator moves the spine shaft to the lower gear and the module checks if the gears are fully align to allow isokinetic mode.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

We claim:

1. An actuator geared feedback system for a resistance training machine, comprising:
an actuator operably coupled to a motor system, wherein the motor system is operatable to provide resistance in a resistance training machine;
the actuator shifts the motor system from a lower gear to a higher gear in a first actuator position, and the actuator shifts the motor system from the higher gear to the lower gear in a second actuator position;
wherein the higher gear includes a plurality of female engagement points for the actuator, and the actuator includes a plurality of male engagement points for the higher gear, such that the plurality of male engagement points lock into the plurality of female engagement points as to lock the actuator in the first actuator position and the higher gear, and preventing a failed shift of the actuator from the lower gear to the higher gear if the plurality of male engagement points do not lock into the plurality of female engagement points, then the actuator is biased by a spring to force the plurality of male engagement points into the plurality of female engagement points.

2. The motor gear system of claim 1, wherein the first actuator position is operably coupled to a first switch to confirm the actuator is in the first actuator position; and the second actuator position is operably coupled to a second switch to confirm the actuator is in the second actuator position.

3. The motor gear system of claim 2, wherein the plurality of female engagement points and the plurality of male engagement points include a conical configuration.

4. The motor gear system of claim 2, wherein the plurality of female engagement points and the plurality of male engagement points include a chaffered configuration.

5. The motor gear system of claim 2, wherein the plurality of female engagement points and the plurality of male engagement points include an angled chaffered configuration.

6. The motor gear system of claim 3, wherein the low gear is between about 1.6:1 and about 4.8:1 and the high gear is between about 22:1 to about 66:1.

7. The motor gear system of claim 6, wherein the actuator is operably coupled to the machine controller.

8. The motor gear system of claim 7, wherein the higher gear operates in an isokinetic mode and the lower gear operates in an isotonic mode or a calibration mode.

9. The motor gear system of claim 8, wherein the motor system further comprises a neutral gear position between the higher gear and the lower gear.

10. The motor gear system of claim 9, wherein the outer shifter shaft includes oil that smooths the shifting of the actuator and an O-ring that keeps oil from leaking past the inner shifter shaft.

11. The motor gear system of claim 10, further comprises a rotary seal coaxially coupled with the outer shifter shaft to keep oil from leaking out of the area around the outer shifter shaft.
